(19) United States
(12) Patent Application Publication
(10) Pub. No.: US 2021/0405462 A1
(43) Pub. Date: Dec. 30, 2021

(54) PIXEL ELECTRODE STRUCTURE AND LIQUID CRYSTAL DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventors: Yinfeng ZHANG, Shenzhen (CN); Yunglun LIN, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/627,776

(22) PCT Filed: Dec. 4, 2019
(86) PCT No.: PCT/CN2019/122850

§ 371 Date: Dec. 31, 2019

(30) Foreign Application Priority Data
Nov. 26, 2019 (CN) 201911175624.6

(51) Int. Cl. G02F 1/1343

(52) U.S. Cl. CPC G02F 1/134309

(57) ABSTRACT

The present application provides a pixel electrode structure and a liquid crystal display panel. Each first sub electrode is disposed correspondingly to a second sub electrode. A gap is disposed between an end of each of the first sub electrodes and an end of a corresponding one of the second sub electrodes. The gap and an adjacent gap are interlaced, thereby, reducing dark streaks generated on the boundary, and improving transmittance.

### CROSS REFERENCE TO RELATED APPLICATION

This application claims priority to Chinese Application No. 201911175624.6, filed on 2019 Nov. 26. The title is “Pixel Electrode Structure and Liquid Crystal Display Panel”. The entire disclosure of the above application is incorporated herein by reference.

### BACKGROUND OF INVENTION

### Field of Invention

The present application relates to the field of display technology, and particularly to a pixel electrode structure and a liquid crystal display panel.

### Description of Prior Art

With the gradual promotion of high-definition display panels, major panel manufacturers are competing in developing key display technologies, such as high resolution and low color cast. The aperture ratio and transmittance of a panel are the main constraints for high resolution and low color cast. An existing pixel design for effectively improving the aperture ratio has been proposed, but the transmittance has not improved significantly with the large improvement in aperture ratio. The pixel electrode 800 shown in FIG. 1 includes a first pixel electrode 81 and a second pixel electrode 82. The second pixel electrode 82 surrounds the first pixel electrode 81. Such a pixel electrode structure design can effectively improve the aperture ratio, but there are a large number of dark streaks on the boundary between the first pixel electrode 81 and the second pixel electrode 82, which inhibits the improvement of transmittance.

Therefore, the problem of dark streaks on the boundary of the existing pixel electrode structure needs to be solved.

### SUMMARY OF INVENTION

The present application provides a pixel electrode structure and a liquid crystal display panel to solve the problem of dark streaks on the boundary of the existing pixel electrode structure in prior art.

In order to solve the above problem, the technical solution provided by the present application is as follows:

The present application provides a pixel electrode structure comprising a first pixel electrode and a second pixel electrode; wherein the first pixel electrode comprises a plurality of first sub electrodes, the second pixel electrode comprises a plurality of second sub electrodes, and each of the first sub electrodes is correspondingly disposed to one of the second sub electrodes; wherein a gap is disposed between an end of each of the first sub electrodes and an end of a corresponding one of the second sub electrodes, and the gap and an adjacent gap are interlaced.

In the pixel electrode structure of the present application, a length of one of the first sub electrodes is different from a length of an adjacent one of the first sub electrodes.

In the pixel electrode structure of the present application, the first sub electrodes are parallel to the second sub electrodes.

In the pixel electrode structure of the present application, shapes of the ends of the first sub electrodes and the second sub electrodes are triangular.

In the pixel electrode structure of the present application, t shapes of the ends of the first sub electrodes and the second sub electrodes are rectangular.

In the pixel electrode structure of the present application, the first pixel electrode is divided into four quadrant areas.

In the pixel electrode structure of the present application, the second pixel electrode is divided into four regions, the four regions are correspondingly disposed to the four quadrant areas of the first pixel electrode.

In the pixel electrode structure of the present application, the first pixel electrode also comprises a first main electrode, and the first sub electrodes are connected to the first main electrode.

In the pixel electrode structure of the present application, the second pixel electrode also comprises a second main electrode, and the second sub electrodes are connected to the second main electrode.

In the pixel electrode structure of the present application, an open is disposed at a side of the second main electrode.

The present application provides a liquid crystal display panel comprising a first substrate; a second substrate; a common electrode structure; a pixel electrode structure and liquid crystal molecules. The second substrate is disposed opposite to the first substrate. The common electrode structure is disposed at a side of the first substrate facing the second substrate. The pixel electrode structure is disposed at a side of the second substrate facing the first substrate. The liquid crystal molecules fills between the common electrode structure and the pixel electrode structure. Wherein, the pixel electrode structure comprises a first pixel electrode and a second pixel electrode. Wherein, the first pixel electrode comprises a plurality of first sub electrodes, the second pixel electrode comprises a plurality of second sub electrodes, and each of the first sub electrodes is correspondingly disposed to one of the second sub electrodes. Wherein, a gap is disposed between an end of each of the first sub electrodes and an end of a corresponding one of the second sub electrodes, and the gap and an adjacent gap are interlaced.

In the liquid crystal display panel of the present application, a length of one of the first sub electrodes is different from a length of an adjacent one of the first sub electrodes.

In the liquid crystal display panel of the present application, the first sub electrodes are parallel to the second sub electrodes.

In the liquid crystal display panel of the present application, shapes of the ends of the first sub electrodes and the second sub electrodes are triangular.

In the liquid crystal display panel of the present application, shapes of the ends of the first sub electrodes and the second sub electrodes are rectangular.

In the liquid crystal display panel of the present application, the first pixel electrode is divided into four quadrant areas.

In the liquid crystal display panel of the present application, the second pixel electrode is divided into four regions, the four regions are correspondingly disposed to the four quadrant areas of the first pixel electrode.

In the liquid crystal display panel of the present application, the first pixel electrode also comprises a first main electrode, and the first sub electrodes are connected to the first main electrode.

In the liquid crystal display panel of the present application, the second pixel electrode also comprises a second main electrode, and the second sub electrodes are connected to the second main electrode.

In the liquid crystal display panel of the present application, an open is disposed at a side of the second main electrode.

The benefit of the present application is: in a pixel electrode structure and a liquid crystal display panel provided by the present application, a gap is disposed between an end of each of the first sub electrodes and an end of a corresponding one of the second sub electrodes, and the gap and an adjacent gap are interlaced, thereby generating a cross field on the boundary of the first pixel electrode and the second pixel electrode covering the boundary of the first pixel electrode and the second pixel electrode, effectively controlling liquid crystal molecules lodging on the boundary and reducing dark streaks generated on the boundary to improve transmittance.

### BRIEF DESCRIPTION OF DRAWINGS

In order to more clearly illustrate the embodiments or the technical solutions in the prior art, the drawings to be used in the embodiments or the prior art description will be briefly described below. Obviously, the drawings in the following description are merely inventions. For some embodiments, other drawings may be obtained from those of ordinary skill in the art without departing from the drawings.

FIG. 1 is a top view of a pixel electrode structure in prior art.

FIG. 2 is a first top structural view of a pixel electrode structure of one embodiment according to the present application.

FIG. 3 is a length comparison diagram of a first sub electrode of one embodiment according to the present application.

FIG. 4 is a schematic diagram of a gap disposed between a first sub electrode and a second sub electrode of one embodiment according to the present application.

FIG. 5 is comparison diagram of end structures of sub electrodes of one embodiment according to the present application.

FIG. 6 is a second top structural view of the pixel electrode structure of one embodiment according to the present application.

FIG. 7 is comparison diagram of gaps disposed between the sub electrodes of one embodiment according to the present application.

FIG. 8 is a third top structural view of the pixel electrode structure of one embodiment according to the present application.

FIG. 9 is a side structural schematic diagram of a liquid crystal display panel of one embodiment according to the present application.

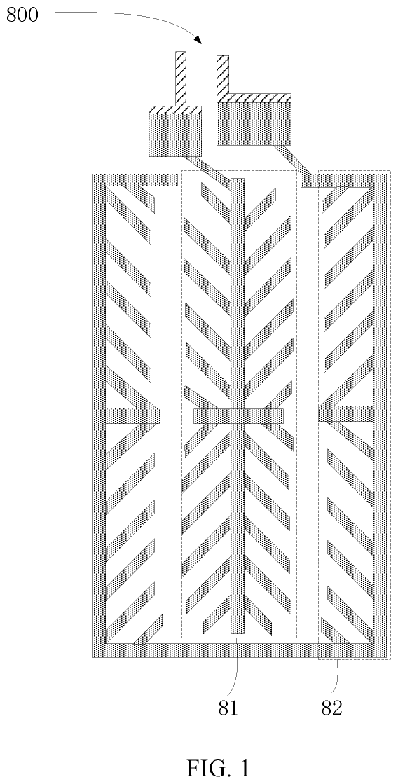

### DETAILED DESCRIPTION OF PREFERRED EMBODIMENTS

The following description of the various embodiments is provided to illustrate the specific embodiments of the invention. Directional terms mentioned in the present invention, such as “upper”, “lower”, “previous”, “post”, “left”, “right”, “inside”, “outside”, “side”, etc., are merely references to the direction of the appended drawings. Therefore, the directional terminology used is for the purpose of illustration and understanding of the invention. In the figures, structurally similar elements are denoted by the same reference numerals.

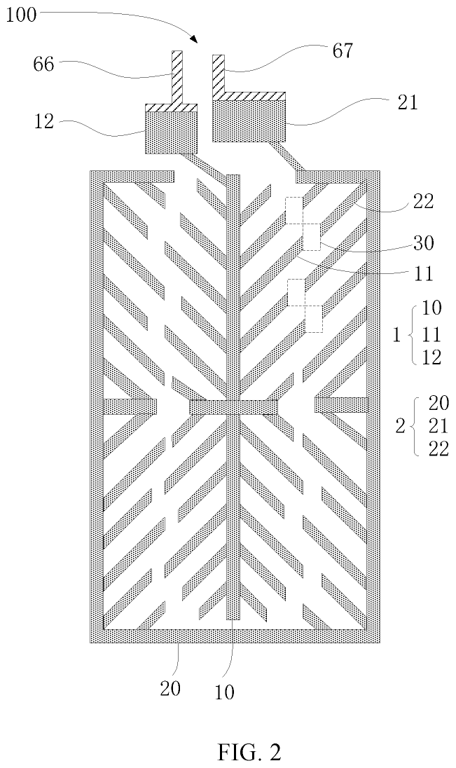

In one embodiment, referring to FIG. 2, a pixel electrode structure 100 is provided and includes a first pixel electrode 1 and a second pixel electrode 2. The first pixel electrode 1 includes a plurality of first sub electrodes 11, the second pixel electrode 2 includes a plurality of second sub electrodes 22. Each of the first sub electrodes 11 is correspondingly disposed to one of the second sub electrodes 22. A gap 30 is disposed between an end of each of the first sub electrodes 11 and an end of a corresponding one of the second sub electrodes 22, and the gap 30 and an adjacent gap 30 are interlaced.

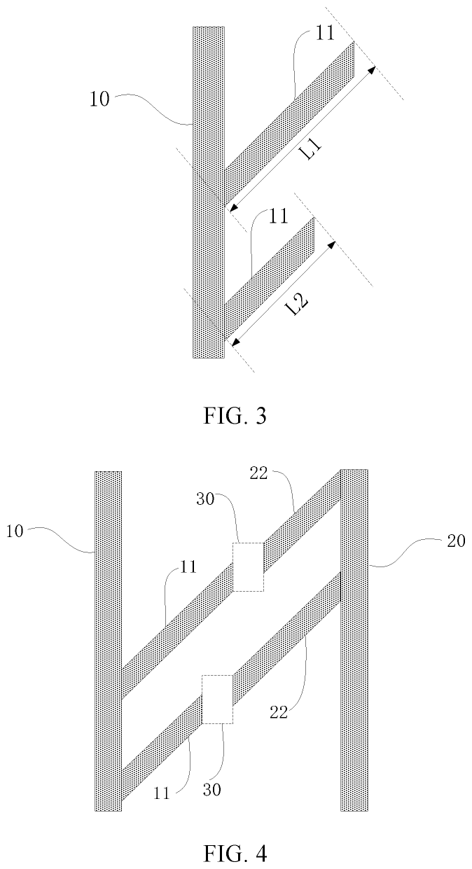

Specifically, a length of one of the first sub electrodes is different from a length of an adjacent one of the first sub electrodes. Referring to FIG. 3, it is an enlarged view of two adjacent first sub electrodes of the pixel electrode 100 in FIG. 2. Illustrated by FIG. 3, a length L1 of one of the first sub electrodes is greater than a length L2 of another adjacent first sub electrode.

Furthermore, because each of the first sub electrodes 11 corresponds to one of the second sub electrodes 22, a length of one of the second sub electrodes is different from a length of another adjacent second sub electrode.

Specifically, because a gap 30 is disposed between an end of each of the first sub electrodes 11 and an end of a corresponding one of the second sub electrodes 22, it can be illustrated by two adjacent first sub electrodes corresponding to two adjacent second sub electrodes as shown in FIG. 4, which is an enlarged view of two adjacent first sub electrodes corresponding to two adjacent second sub electrodes. Illustrated by FIG. 4, a gap 30 is disposed between an end of one of the first sub electrodes 11 and an end of a corresponding one of the second sub electrodes 22, and a gap 30 is disposed between an end of adjacent one of the first sub electrodes 11 and an end of a corresponding adjacent one of the second sub electrodes 22.

Furthermore, a length of one of the first sub electrodes 11 is different from a length of an adjacent one of the first sub electrodes 11, a length of one of the second sub electrodes 22 is different from a length of an adjacent one of the second sub electrodes 22, and gaps 30 disposed between ends of the first sub electrodes 11 and ends of the second sub electrodes 22 are interlaced. Lengths of the first sub electrodes 11 in the pixel electrode structure are different and arranged in a staggered manner, thereby leaving gaps disposed and interlaced between ends of the first sub electrodes and ends of the correspondingly second sub electrodes in the pixel electrode structure.

Furthermore, the gaps are interlaced to generate a cross field on the boundary of the first pixel electrode and the second pixel electrode, and the cross field covers the boundary of the first pixel electrode and the second pixel electrode, thereby effectively controlling liquid crystal molecules lodging on the boundary and reducing dark streaks generated on the boundary to improve transmittance.

Specifically, referring to FIG. 2, the first pixel electrode 1 also includes a first main electrode 10, and the first sub electrodes 11 are connected to the first main electrode 10. The second pixel electrode 2 also includes a second main electrode 20, and the second sub electrodes 22 are connected to the second main electrode 20.

Furthermore, the first pixel electrode 1 is divided into four quadrant areas by the first main electrode 10. The first sub electrodes 11 and the first main electrode are vertically and horizontally symmetrical, which leads to the shape of the pixel electrode structure resembling the Union Jack, that is, the first sub electrodes 11 located in different quadrant areas extend toward different directions.

Furthermore, the second pixel electrode 2 is divided into four regions by the second main electrode 20, and the four regions are correspondingly disposed to the four quadrant areas of the first pixel electrode 1.

Specifically, referring to FIG. 2, an open is disposed on a side of the second main electrode. Specifically, the second main electrode with an open disposed on an upper side thereof is shaped like a hollow square and surrounds the first pixel electrode 1 and second sub electrodes 22.

Furthermore, in the four different regions of the second pixel electrode 2, the second sub electrodes 22 extend to different directions along the second main electrode 20.

Specifically, the ends of the first sub electrodes and the second sub electrodes are ends far away from the main electrode.

Furthermore, in the same quadrant area of the first pixel electrode 1 and the corresponding region of the second pixel electrode 2, the first sub electrodes are parallel to the second sub electrodes.

In one embodiment, the open disposed at the upper side of the second main electrode 20 is configured for external connection of the first pixel electrode 1.

Specifically, referring to FIG. 2, the pixel electrode structure 100 also includes a first connecting electrode 12 and a second connecting electrode 21. The first connecting electrode 12 is connected to the first main electrode 10 and the first drain electrode 66 by the open disposed at the upper side of the second main electrode 20, and the second connecting electrode 27 is connected to the second main electrode 20 and a second drain electrode 67.

Furthermore, the first pixel electrode 1 and the second pixel electrode 2 are controlled by two thin film transistors (TFTs) respectively.

In one embodiment, the first pixel electrode and the second pixel electrode are made of transparent conductive material as indium tin oxide (ITO).

In one embodiment, referring to FIG. 2, shapes of the ends of the first sub electrodes 11 and the second sub electrodes 22 are triangular. The ends are the ends of the first sub electrodes 11 and the ends of the second sub electrodes 22.

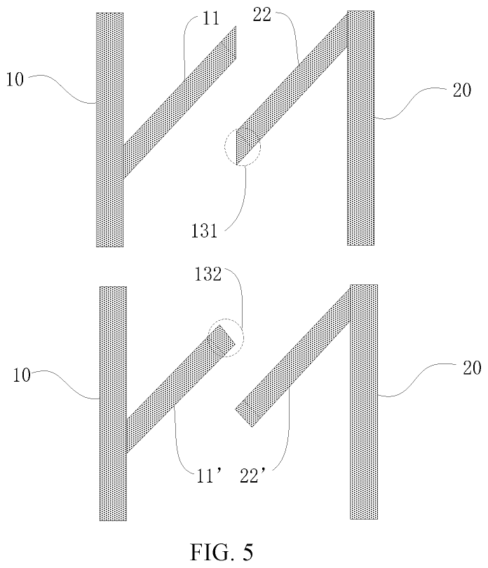

In one embodiment, different from the above embodiments, shapes of the ends of the first sub electrodes and the second sub electrodes are rectangular. Difference between the end shaped like a triangular and the end shaped like a rectangular is: small parts of the ends of the first sub electrode and the second sub electrode is selected, from a top view, which is shown as a triangular 131 and a rectangular 132 in FIG. 5.

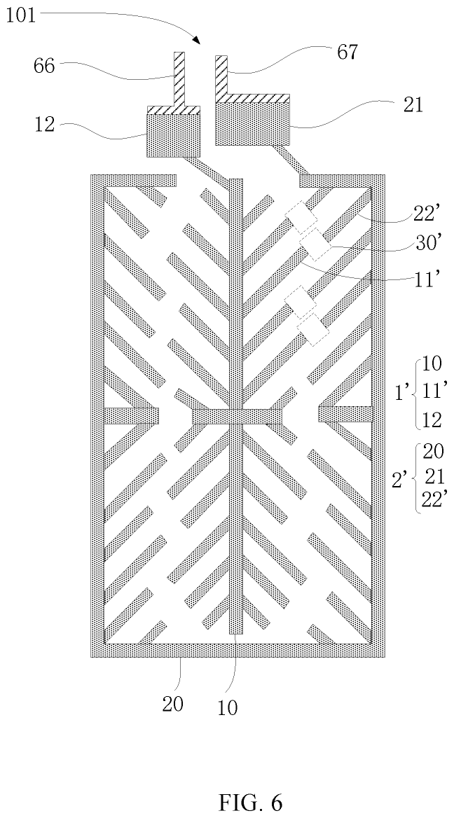

Specifically, the pixel electrode structure 101 shown as FIG. 6 includes a first pixel electrode 1′ and a second pixel electrode 2′.

Specifically, the first pixel electrode 1′ includes a first main electrode 10 and a plurality of first sub electrodes 11′, the first sub electrodes 11′ extend along the first main electrode 10 toward different directions.

Specifically, the second pixel electrode 2′ includes a second main electrode 20 and a plurality of second sub electrodes 22′, the second sub electrodes 22′ extend along the second main electrode 20 toward different directions.

Furthermore, each one of the first sub electrodes 11′ corresponds to one of the second sub electrodes 22′. A gap 30′ is disposed between an end of each of the first sub electrodes 11′ and an end of a corresponding one of the second sub electrodes 22′, and the gap 30′ and another adjacent gap 30′ are interlaced.

In one embodiment, different from the above embodiments, the length difference between one of the first sub electrodes and another adjacent one of the first sub electrodes increases, so a distance between a gap disposed between an end of one of the first sub electrodes and an end of an correspondingly second electrode and a gap between adjacent sub electrodes increases.

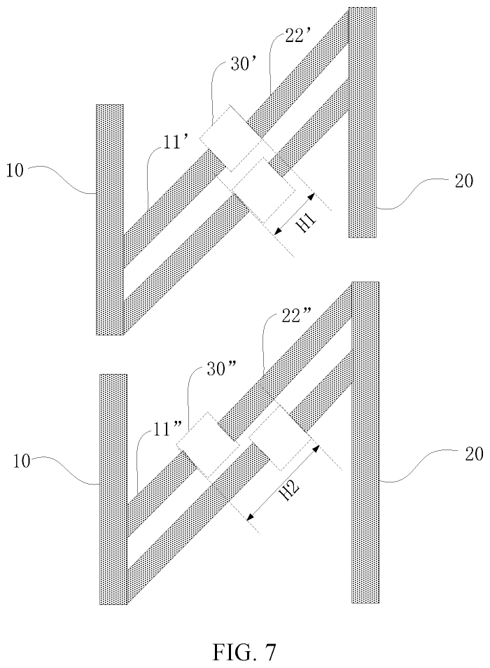

Specifically, FIG. 7 is a comparison diagram of gaps disposed between the sub electrodes of this embodiment and gaps of disposed between the sub electrodes of the above embodiment of FIG. 6. Illustrated in FIG. 7, a distance H1 between the adjacent gaps 30′ interlaced of the above embodiment is less than a distance H2 between the adjacent gaps 30″ interlaced of this embodiment.

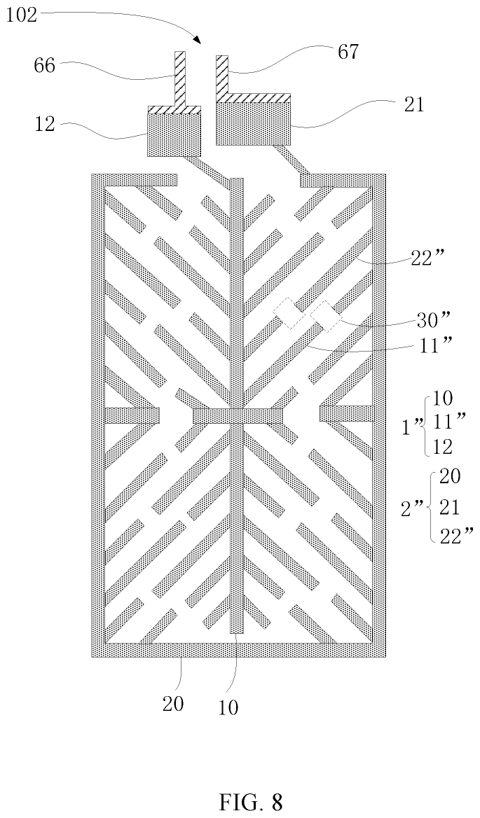

Specifically, the pixel electrode structure 102 of this embodiment shown as FIG. 8 includes a first pixel electrode 1″ and a second pixel electrode 2″. A gap 30″ is disposed between an end of each of the first sub electrodes 11″ and an end of a corresponding one of the second sub electrodes 22″, and the gap 30″ and an adjacent gap 30″ are interlaced. For more explanations, please refer to the above embodiments.

Furthermore, a distance between the interlaced adjacent gap 30″ increases, that is, an overlapping region of the ends of the first sub electrodes 11″ and the ends of the adjacent second sub electrodes 22″ increases, which leads to a larger covered region of a cross field on the boundary of the first pixel electrode 1″ and the second pixel electrode 2″.

In another embodiment, when the ends of the first sub electrodes and the second sub electrodes are triangular, the scheme of the above embodiments may also be adopted. For more explanations, please refer to the above embodiments.

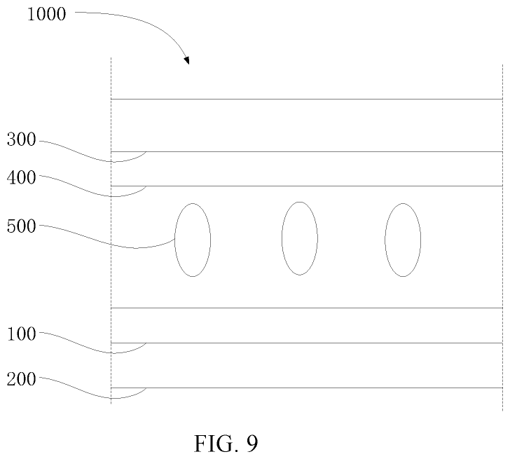

In one embodiment, a liquid crystal display panel 1000 is also provided. Referring to FIG. 9, the liquid crystal display panel 1000 includes a first substrate 300, a second substrate 200, a common electrode structure 400, a pixel electrode structure 100, and liquid crystal molecules 500. The second substrate 200 is disposed opposite to the first substrate 300. The common electrode structure 400 is disposed at one side of the first substrate 300 facing the second substrate 200. The pixel electrode structure 100 is disposed at one side of the second substrate 200 facing the first substrate 300. The liquid crystal molecules 500 are filled between the common electrode structure 400 and the pixel electrode structure 100. The pixel electrode structure includes a first pixel electrode and a second pixel electrode. The first pixel electrode includes a plurality of first sub electrodes, the second pixel electrode includes a plurality of second sub electrodes, and each of the first sub electrodes is correspondingly disposed to one of the second sub electrodes, wherein a gap is disposed between an end of each of the first sub electrodes and an end of a corresponding one of the second sub electrodes, and the gap and another adjacent gap are interlaced.

Specifically, a length of one of the first sub electrodes is different from a length of another adjacent one of the first sub electrodes.

Specifically, the first sub electrodes are parallel to the second sub electrodes.

Specifically, shapes of the ends of the first sub electrodes and the second sub electrodes are triangular.

Specifically, shapes of the ends of the first sub electrodes and the second sub electrodes are rectangular.

Specifically, the first pixel electrode is divided into four quadrant areas.

Specifically, he second pixel electrode is divided into four regions, and the four regions are correspondingly disposed to the four quadrant areas of the first pixel electrode.

Specifically, the first pixel electrode also includes a first main electrode, and the first sub electrodes are connected to the first main electrode.

Specifically, the second pixel electrode also includes a second main electrode, and the second sub electrodes are connected to the second main electrode.

Specifically, an open is disposed at a side of the second main electrode.

From the above:

The present application provides a pixel electrode structure and a liquid crystal display panel, and the pixel electrode structure includes a first pixel electrode and a second pixel electrode. Each of the first sub electrodes is correspondingly disposed to one of the second sub electrodes. A gap is disposed between an end of each of the first sub electrodes and an end of a corresponding one of the second sub electrodes, and the gap and an adjacent gap are interlaced, thereby generating a cross field on the boundary of the first pixel electrode and the second pixel electrode covering the boundary of the first pixel electrode and the second pixel electrode, effectively controlling liquid crystal molecules lodging at the boundary and reducing dark streaks generated at the boundary to improve transmittance.

In summary, although the present application has been disclosed above with preferred embodiments, the above preferred embodiments are not intended to limit the present application. Those skilled in the art can make various modifications without departing from the spirit and scope of the present application. This kind of modification and retouching, therefore, the protection scope of this application shall be subject to the scope defined by the claims.

What is claimed is:

1. A pixel electrode structure, comprising a first pixel electrode and a second pixel electrode; wherein the first pixel electrode comprises a plurality of first sub electrodes, the second pixel electrode comprises a plurality of second sub electrodes, and each of the first sub electrodes is correspondingly disposed to one of the second sub electrodes; wherein a gap is disposed between an end of each of the first sub electrodes and an end of a corresponding one of the second sub electrodes, and the gap and an adjacent gap are interlaced.

2. The pixel electrode structure of claim 1, wherein a length of one of the first sub electrodes is different from a length of an adjacent one of the first sub electrodes.

3. The pixel electrode structure of claim 1, wherein the first sub electrodes are parallel to the second sub electrodes.

4. The pixel electrode structure of claim 1, wherein shapes of the ends of the first sub electrodes and the second sub electrodes are triangular.

5. The pixel electrode structure of claim 1, wherein shapes of the ends of the first sub electrodes and the second sub electrodes are rectangular.

6. The pixel electrode structure of claim 1, wherein the first pixel electrode is divided into four quadrant areas.

7. The pixel electrode structure of claim 6, wherein the second pixel electrode is divided into four regions, the four regions are correspondingly disposed to the four quadrant areas of the first pixel electrode.

8. The pixel electrode structure of claim 1, wherein the first pixel electrode also comprises a first main electrode, and the first sub electrodes are connected to the first main electrode.

9. The pixel electrode structure of claim 1, wherein the second pixel electrode also comprises a second main electrode, and the second sub electrodes are connected to the second main electrode.

10. The pixel electrode structure of claim 9, wherein an open is disposed at a side of the second main electrode.

11. A liquid crystal display panel, comprising:
a first substrate;
a second substrate disposed opposite to the first substrate;
a common electrode structure disposed at a side of the first substrate facing the second substrate;
a pixel electrode structure disposed at a side of the second substrate facing the first substrate; and
liquid crystal molecules filled between the common electrode structure and the pixel electrode structure;
wherein the pixel electrode structure comprises a first pixel electrode and a second pixel electrode; wherein the first pixel electrode comprises a plurality of first sub electrodes, the second pixel electrode comprises a plurality of second sub electrodes, and each of the first sub electrodes is correspondingly disposed to one of the second sub electrodes; wherein a gap is disposed between an end of each of the first sub electrodes and an end of a corresponding one of the second sub electrodes, and the gap and an adjacent gap are interlaced.

12. The liquid crystal display panel of claim 11, wherein a length of one of the first sub electrodes is different from a length of an adjacent one of the first sub electrodes.

13. The liquid crystal display panel of claim 11, wherein the first sub electrodes are parallel to the second sub electrodes.

14. The liquid crystal display panel of claim 11, wherein shapes of the ends of the first sub electrodes and the second sub electrodes are triangular.

15. The liquid crystal display panel of claim 11, wherein shapes of the ends of the first sub electrodes and the second sub electrodes are rectangular.

16. The liquid crystal display panel of claim 11, wherein the first pixel electrode is divided into four quadrant areas.

17. The liquid crystal display panel of claim 16, wherein the second pixel electrode is divided into four regions, the four regions are correspondingly disposed to the four quadrant areas of the first pixel electrode.

18. The liquid crystal display panel of claim 11, wherein the first pixel electrode also comprises a first main electrode, and the first sub electrodes are connected to the first main electrode.

19. The liquid crystal display panel of claim 11, wherein the second pixel electrode also comprises a second main electrode, and the second sub electrodes are connected to the second main electrode.

20. The liquid crystal display panel of claim 11, wherein an open is disposed at a side of the second main electrode.
